(19) United States
(12) Patent Application Publication
(10) Pub. No.: US 2009/0169950 A1
(43) Pub. Date: Jul. 2, 2009

(54) PRODUCTION OF CATALYST COATED MEMBRANES

(75) Inventors: DAVID NEVILLE PRUGH, Sayre, PA (US); Harvey P. Tannenbaum, Wynnewood, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/344,910

(22) Filed: Dec. 29, 2008

Related U.S. Application Data
(60) Provisional application No. 61/017,196, filed on Dec. 28, 2007.

(51) Int. Cl. H01M 8/10; H01M 4/88

(52) U.S. Cl. 429/30; 502/101

(57) ABSTRACT

Disclosed is process for the production of catalyst coated membranes, and catalyst coated membranes having a first electrode that is visually more reflective than the second electrode. The catalyst coated membranes are useful in electrochemical cells, and especially in fuel cells.

### CROSS REFERENCE(S) TO RELATED APPLICATION(S)

This application claims the priority benefit of U.S. Provisional Patent Application No. 61/017,196, filed Dec. 28, 2007.

### FIELD OF THE INVENTION

This disclosure relates to a process for producing catalyst coated membranes and to catalyst coated membranes for use in electrochemical cells, especially for use in fuel cells.

### BACKGROUND OF THE INVENTION

A variety of electrochemical cells fall within a category often referred to as solid polymer electrolyte (“SPE”) cells. An SPE cell typically employs a membrane of a cation exchange polymer that serves as a physical separator between the anode and cathode while also serving as an electrolyte. SPE cells can be operated as electrolytic cells for the production of electrochemical products or they may be operated as fuel cells.

Fuel cells are electrochemical cells that convert reactants, namely fuel and oxidant fluid streams, to generate electric power and reaction products. A broad range of reactants can be used in fuel cells and such reactants may be delivered in gaseous or liquid streams. For example, the fuel stream may be substantially pure hydrogen gas, a gaseous hydrogen-containing reformate stream, or an aqueous alcohol, for example methanol in a direct methanol fuel cell (DMFC). The oxidant may, for example, be substantially pure oxygen or a dilute oxygen stream such as air.

In SPE fuel cells, the solid polymer electrolyte membrane is typically comprised of a fluorinated polymer such as a perfluorinated sulfonic acid polymer. Such fuel cells are often referred to as proton exchange membrane (“PEM”) fuel cells. The membrane is disposed between and in contact with the anode and the cathode electrodes. Electrocatalysts in the anode and the cathode typically induce the desired electrochemical reactions and may be, for example, an alloy or a metal catalyst supported on a substrate such as platinum on carbon. SPE fuel cells typically also comprise a porous, electrically conductive sheet material that is in electrical contact with each of the electrodes, that facilitates diffusion of the reactants to the electrodes. In fuel cells that employ gaseous reactants, this porous, conductive sheet material is sometimes referred to as a gas diffusion layer and is suitably provided as a carbon fiber paper or carbon cloth. An assembly including the membrane, anode and cathode, and gas diffusion layers for each electrode, is sometimes referred to as a membrane electrode assembly (“MEA”). Bipolar plates, made of a conductive material and providing flow fields for the reactants, are placed between adjacent MEAs. A number of MEAs and bipolar plates are assembled in this manner to provide a fuel cell stack.

Essentially two approaches have been taken to form electrodes for SPE fuel cells. In one, the electrodes are formed on the gas diffusion layers by coating electrocatalyst and dispersed particles of PTFE in a suitable liquid medium onto the gas diffusion layer, e.g., carbon fiber paper. The carbon fiber paper with the electrodes attached and a membrane are then assembled into an MEA by pressing such that the electrodes are in contact with the membrane. In MEAs of this type, it is difficult to establish the desired ionic contact between the electrode and the membrane due to the lack of intimate contact. As a result, the interfacial resistance may be higher than desired. In the other main approach for forming electrodes, electrodes are formed onto the surface of the membrane. A membrane having electrodes so formed is often referred to as a catalyst coated membrane (“CCM”). Employing CCMs can provide improved performance over forming electrodes on the gas diffusion layer but CCMs are typically much more difficult to manufacture. Casting both electrodes from solvent onto an unsupported membrane causes the membrane it to swell and wrinkle which results in a low yield production process.

Various manufacturing methods have been developed for manufacturing CCMs. Many of these processes have employed electrocatalyst coating slurries containing the electrocatalyst and the ion exchange polymer and, optionally, other materials such as a PTFE dispersion. The ion exchange polymer in the membrane itself, and in the electrocatalyst coating solution is employed in either hydrolyzed or unhydrolyzed ion-exchange polymer (sulfonyl fluoride form when perfluorinated sulfonic acid polymer is used), and in the latter case, the polymer must be hydrolyzed during the manufacturing process. A variety of techniques have been developed for CCM manufacture which apply an electrocatalyst coating solution containing the ion exchange polymer directly to membrane. However, coated fluorinated polymer membranes are dimensionally unstable and are very difficult to handle in efficient high volume manufacturing operations. Utilized coating techniques such as spraying, painting, patch coating and screen printing are typically slow, can cause loss of valuable catalyst and require the application of relatively thick coatings. Drying the coated electrodes has also been found to slow the CCM manufacturing process.

In some CCM manufacturing processes, “decals” are first made by depositing the electrocatalyst coating solution on another substrate, removing the solvent and then transferring and adhering the resulting electrode decals to the membrane. Mechanical handling of electrode decals, placement of decals on the membrane, and hot pressing of the electrode decals onto the membrane is difficult to perform in efficient high volume manufacturing operations.

As described above, CCMs are incorporated into MEAs by arranging the MEAs between gas diffusion layers and bipolar plates. Often, the anode and cathode electrodes have different compositions that are each specially tailored to the chemical reaction occurring at the particular electrode. During assembly, the cathode and anode electrodes can be confused which results in CCMs being placed backwards in MEAs. Improper installation of such uniquely designed electrodes results in poor MEA performance.

Accordingly, a process is needed which is suitable for the high volume production of CCMs and which avoids problems associated with prior art processes. Further, a process is needed which results in CCMs in which the cathode and anode electrodes are readily distinguishable from each other.

### BRIEF DESCRIPTION OF THE DRAWINGS

FIG. 1 is a schematic representation of a process for making catalyst coated membranes disclosed herein.

FIG. 2 is a cross section of the layered structure at the point designated by the reference character 14 in FIGS. 1 and 7.

FIG. 3 is a cross section of the layered structure at the point designated by the reference character 20 in FIGS. 1 and 7.

FIG. 4 is a cross section of the layered structure at the point designated by the reference character 32 in FIG. 1.

FIG. 5 is a cross section of the layered structure at the point designated by the reference character 40 in FIGS. 1 and 7.

FIG. 6 is a cross section of the layered structure at the point designated by the reference character 46 in FIGS. 1 and 7.

FIG. 7 is a schematic representation of another process for making catalyst coated membranes disclosed herein.

FIG. 8 is a cross section of the structure at the point designated by the reference character 41 in FIG. 7.

FIG. 9 is a cross section of the layered structure at the point designated by the reference character 67 in FIG. 7.

FIG. 10 is a cross section of the layered structure at the point designated by the reference character 51 in FIG. 7.

FIG. 11 is a cross section of the layered structure at the point designated by the reference character 53 in FIG. 7.

FIG. 12 is a graph of voltage vs. current density measured on a CCM made as described in the Examples.

### DETAILED DESCRIPTION OF THE INVENTION

Disclosed herein is a process for manufacturing catalyst coated membranes. According to this process, a fluorinated polymer membrane is provided. The membrane has a first surface adhered to a dimensionally stable substrate and an opposite second surface. A first electrocatalyst coating composition comprised of a fluorinated polymer, a catalyst and a liquid medium is also provided. The liquid medium is comprised of greater than 70 wt % of a liquid having a boiling point less than 120° C. In the disclosed process, the electrocatalyst coating composition is applied on at least a portion of the second surface of the membrane and is dried to form a first electrode on the membrane. The first electrode has a first surface adjacent to the second surface of the membrane and an opposite exposed second surface.

In the disclosed process, an electrode decal is also provided. The electrode decal comprises a second electrode on a dimensionally stable release substrate. The electrode decal is prepared by: (1) providing a second electrocatalyst coating composition comprised of a fluorinated polymer, a catalyst and a liquid medium, where the liquid medium is comprised of greater than 70 wt % of a liquid having a boiling point less than 120° C.; (2) providing a dimensionally stable release substrate having a surface; (3) applying the second electrocatalyst coating composition on at least a portion of the surface of the dimensionally stable release substrate; and (4) drying the second electrocatalyst coating composition on the release substrate to form an electrode decal on the dimensionally stable release substrate. The electrode decal has a first surface adjacent to the dimensionally stable release substrate and an opposite second surface.

In the disclosed process, the first dimensionally stable substrate is removed from the first surface of the polymer membrane, and the second surface of the electrode decal is applied to the first surface of the polymer membrane so as to form a sandwich of the polymer membrane between the first electrode and the electrode decal. According to the disclosed process, the sandwich of the polymer membrane between the first electrode and the electrode decal is passed through a compression nip formed between a heated roller and another roller to adhere the electrode decal to the membrane. The dimensionally stable release substrate is then removed from the first surface of the electrode decal to expose the first surface of the electrode decal. The exposed first surface of the electrode decal has a visual surface appearance that is different and more reflective than the visual surface appearance of the exposed second surface of the first electrode.

### Fluorinated Polymer Membrane

The fluorinated polymer membrane is a proton exchange membrane (“PEM”) comprised of ion-exchange polymer. Ion-exchange polymers suitable for use in making PEMs of the catalyst coated membranes made according to the disclosed process include those polymers known for use in various types of fuel cells including, for example, highly fluorinated ion-exchange polymers. “Highly fluorinated” means that at least 90% of the total number of univalent atoms in the polymer are fluorine atoms. Most typically, the polymer is perfluorinated. It is typical for polymers used in PEMs to have sulfonate ion exchange groups. The term “sulfonate ion exchange groups” as used herein means either sulfonic acid groups or salts of sulfonic acid groups, typically alkali metal or ammonium salts.

The ion-exchange polymer employed comprises a polymer backbone with recurring side chains attached to the backbone with the side chains carrying the ion-exchange groups. Homopolymers or copolymers or blends thereof can be used. Copolymers are typically formed from one monomer that is a nonfunctional monomer and that provides atoms for the polymer backbone, and a second monomer that provides atoms for the polymer backbone and also contributes a side chain carrying a cation exchange group or its precursor, e.g., a sulfonyl halide group such a sulfonyl fluoride (—SO₂F), which can be subsequently hydrolyzed to a sulfonate ion exchange group. For example, copolymers of a first fluorinated vinyl monomer together with a second fluorinated vinyl monomer having a sulfonyl fluoride group (—SO₂F) can be used. The sulfonic acid form of the polymer may be utilized to avoid post treatment acid exchange steps. Exemplary first fluorinated vinyl monomers include tetrafluoroethylene (TFE), hexafluoropropylene, vinyl fluoride, vinylidine fluoride, trifluoroethylene, chlorotrifluoroethylene, perfluoro (alkyl vinyl ether), and mixtures of two or more thereof. Exemplary second monomers include fluorinated vinyl ethers with sulfonate ion exchange groups or precursor groups that can provide the desired side chain in the polymer. The first monomer can also have a side chain that does not interfere with the ion exchange function of the sulfonate ion exchange group. Additional monomers can also be incorporated into the polymers if desired.

Typical polymers for use in the PEMs include polymers having a highly fluorinated, most typically a perfluorinated, carbon backbone with a side chain represented by the formula —(O—CF₂CFRf)ₐ—(O—CF₂)_{c}— (CFR′f)_{b}SO₃M, where Rf and R′f are independently selected from F, Cl or a perfluorinated alkyl group having 1 to 10 carbon atoms, a=0, 1 or 2, b=0 to 6, and c=0 to 1, and M is H, Li, Na, K or N(R₁)(R₂)(R₃)(R₄) and R₁, R₂, R₃, and R₄ are the same or different and are H, CH₃ or C₂H₅. Specific examples of suitable polymers include those disclosed in U.S. Pat. Nos. 3,282,875; 4,358,545; and 4,940,525. One exemplary polymer comprises a perfluorocarbon backbone and a side chain represented by the formula —O—CF₂CF(CF₃)—O—CF₂CF₂SO₃H. Such polymers are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanging to convert to the acid form, also known as the proton form. Another ion-exchange polymer of the type disclosed in U.S. Pat. Nos. 4,358,545 and 4,940,525 has a side chain —O—CF₂CF₂SO₃H. The polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange. Suitable perfluorinated polymer ion-exchange membranes in sulfonic acid form are available under the trademark Nafion® from E.I. du Pont de Nemours and Company, Wilmington, Del. One suitable membrane is a 1 to 2 mil thick cast PFSA membrane such as Nafion® 211 membrane in the proton form.

For perfluorinated polymers of the type described hereinabove, the ion-exchange capacity of a polymer can be expressed in terms of ion-exchange ratio (“IXR”). Ion-exchange ratio is the number of carbon atoms in the polymer backbone in relation to the ion-exchange groups. A wide range of IXR values for the polymer are possible. Typically, however, the IXR range for perfluorinated sulfonate polymers is from about 7 to about 33. A range for IXR for such a polymer is from about 8 to about 23 (750 to 1500 Equivalent Weight), and a more preferred range is from about 9 to about 15 (800 to 1100 EW). Equivalent weight (EW) is defined to be the weight of the polymer in sulfonic acid form required to neutralize one equivalent of NaOH, and is expressed in units of grams per mole.

The membranes can be made by known extrusion or casting techniques and may have thicknesses that can vary depending upon the intended application. The membranes typically have a thickness of 300 μm or less, with some membranes have a thickness of 50 μm or less, and even 20 microns or less.

Reinforced perfluorinated ion exchange polymer membranes can also be utilized in the CCM manufacturing process disclosed herein. Reinforced membranes can be made by impregnating a porous substrate with ion-exchange polymer. The porous substrate may improve mechanical properties for some applications and/or decrease costs. The porous substrate can be made from a wide range of materials, such as but not limited to non-woven or woven fabrics, using various weaves such as the plain weave, basket weave, leno weave, or others. The porous support may be made from glass, hydrocarbon polymers such as polyolefins, (e.g., polyethylene, polypropylene, polybutylene, and copolymers), and perhalogenated polymers such as polychlorotrifluoroethylene. Porous inorganic or ceramic materials may also be used. For resistance to thermal and chemical degradation, the support typically is made from a fluoropolymer, more typically a perfluoropolymer. For example, the perfluoropolymer of the porous support can be a microporous film of polytetrafluoroethylene (PTFE) or a copolymer of tetrafluoroethylene. Microporous PTFE films and sheeting are known that are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids. Impregnation of expanded PTFE (ePTFE) with perfluorinated sulfonic acid polymer is disclosed in U.S. Pat. Nos. 5,547,551 and 6,110,333. ePTFE is available under the trade name “Goretex” from W. L. Gore and Associates, Inc., Elkton, Md., and under the trade name “Tetratex” from Tetratec, Feasterville, Pa.

The membrane used in the CCM manufacturing process disclosed herein is supported on a dimensionally stable substrate or release layer. Suitable dimensionally stable release substrates materials include substrates made of polyesters including polyethylene terephthalate, polyethylene naphthanate, polyamides, polycarbonates, fluoropolymers, polyacetals, polyolefins, and combinations thereof. Some examples of polyester films include Mylar® or Melinex® polyester films. Some dimensionally stable release substrates having high temperature stability include polyimide films such as Kapton® films or Teflon® PFA film (both available from E. I. du Pont de Nemours and Company, Wilmington, Del.).

### Electrocatalyst Coating Composition

The electrocatalyst coating composition is an ink or paste comprised of an electrocatalyst, a fluorinated ion exchange polymer, and a suitable liquid medium. The medium should be comprised of at least 70 wt % of a liquid with a boiling point of less than 120° C. such that rapid drying of electrode layers is possible under the process conditions employed. A preferred liquid medium is one that will quickly evaporate or vaporize when heated by hot air at a temperature of from 80 to 160° F. provided from a hot air dryer or blower. The liquid medium is typically a polar organic liquid for compatibility with the ion exchange polymer, and is preferably able to wet the proton exchange membrane.

For the electrodes of a CCM to function effectively in fuel cells, effective anode and cathode electrocatalyst sites must be provided in the anode and cathode electrodes. In order for the anode and cathode to be effective: (1) the electrocatalyst sites must be accessible to the reactant, (2) the electrocatalyst sites must be electrically connected to the gas diffusion layer, and (3) the electrocatalyst sites must be ionically connected to the PEM. In the disclosed CCMs, the electrode electrocatalyst sites are ionically connected to the PEM via the ion exchange polymer binder of the electrode. The ion exchange polymer used in making the electrodes is a fluorinated ionomer as described above in the discussion of the PEM. Because the binder employed in the electrode serves not only as binder for the electrocatalyst particles, but may also assist in securing the electrode to the membrane, it is preferred that the ion exchange polymers in the binder composition be compatible with the ion exchange polymer in the membrane. Most typically, ion exchange polymers in the binder composition are the same as the ion exchange polymer in the membrane.

The electrocatalyst in the coating compositions are selected based on the particular intended application for the CCM. Electrocatalysts suitable for use in the disclosed process include one or more noble group metals such as platinum, ruthenium, rhodium, and iridium and electroconductive oxides thereof, and electroconductive reduced oxides thereof. The catalyst may be supported or unsupported. Typically used electrocatalyst compositions for hydrogen fuel cells are platinum or platinum alloys on carbon, for example, 60 wt % carbon, 40 wt % platinum.

In order to form the anode or cathode electrodes, the anode electrocatalyst or the cathode electrocatalyst is slurried with the dispersion of a fluorinated ion exchange polymer, preferably in an organic liquid such as alcohol or a water/alcohol mixture to form a catalyst dispersion. Any additional additives such as are commonly employed in the art may also be incorporated into the slurry. A variety of polar organic liquids and mixtures thereof can serve as suitable liquid media for the electrocatalyst coating ink or paste. Water can be present in the medium if it does not interfere with the coating process. Although some polar organic liquids can swell the membrane when present in sufficiently large quantity, the amount of liquid used in the electrocatalyst coating is preferably small enough that the adverse effects from swelling during the process are minor or undetectable. The liquid medium of the electrocatalyst coating compositions is preferably comprised of at least 70 wt % of alcohol having a boiling point of less than 120° C. and more preferably less than 100° C. A variety of alcohols are well suited for use as the liquid medium including C₄ to C₈ alkyl alcohols such as n-, iso-, sec- and tert-butyl alcohols. Preferred alcohols include propanol (such as n-propyl alcohol and iso-propyl alcohol), n-butanol and n-hexanol. Mixtures of 1-propanol and 2-propanol have been advantageously used as the liquid medium/solvent in the electrocatalyst coating composition. Other organic liquids that can be present in the liquid medium including fluorinated solvents such as the primarily 12 carbon perfluoro compounds of FC-40 and FC-70 Fluorinert™ brand electronic liquids from 3M Company, and dipropylene-glycol monomethyl ether. The amount of liquid medium used in the electrocatalyst coating composition varies and is determined by the type of medium employed, the constituents of the electrocatalyst coating composition, the type of coating equipment employed, the desired electrode thickness, process speeds etc.

The size of the particles in the electrocatalyst coating composition is reduced by grinding, milling and/or sonication to obtain a particle size that result in the best utilization of the electrocatalyst. The particle size, as measured by a Hegman gauge, is reduced to less than 10 microns and more preferably to less than 5 microns. The catalyst/support particles in the electrode are often less than 1 μm in size.

In the process disclosed herein, the electrocatalyst coating composition is coated directly onto one side of the membrane and onto a dimensionally stable release substrate. Known electrocatalyst coating techniques can be used to produce a variety of applied layers of essentially any thickness ranging from very thick, e.g., 30 μm or more, to very thin, e.g., 1 μm or less. A slot die coating process is disclosed for coating the electrocatalyst coating composition onto a membrane or onto a release substrate in order to produce the electrodes of CCMs. Slot die coating is a pre-metered method in which the coating composition is pumped through a precision slot and applied at close proximity onto a moving substrate. Alternative methods for applying the electrocatalyst coating composition onto a substrate may be used including spraying, painting, patch coating and screen printing or flexographic printing. The thickness of the anode and cathode electrodes typically ranges from about 2 microns to about 30 microns.

In the process described herein, one of the electrodes is coated directly onto the membrane while the other electrode is coated onto a dimensionally stable release substrate for subsequent decal transfer onto the membrane while the membrane is adhered to a dimensionally stable substrate. In one embodiment, the electrocatalyst coating composition is coated from a slot die directly onto one side of the membrane. Alternatively, the electrocatalyst coating composition may be applied to one side of the membrane by screen printing or flexographic printing techniques. The second electrode is prepared as a decal by spreading, printing or coating the electrocatalyst coating composition on a flat dimensionally stable release substrate. Suitable dimensionally stable release substrates materials include substrates made of polyesters including polyethylene terephthalate, polyethylene naphthanate, polyamides, polycarbonates, fluoropolymers, polyacetals, polyolefins, and combinations thereof. Some examples of polyester films include Mylar® or Melinex® polyester films. Some dimensionally stable release substrates having high temperature stability include polyimide films such as Kapton® films or Teflon® PFA film (both available from E. I. du Pont de Nemours and Company, Wilmington, Del.). The electrode decal is transferred to the surface of the membrane by the application of pressure and heat applied between heated rollers, followed by removal of the dimensionally stable release substrate to provide a CCM as described in more detail below.

### CCM Preparation Process

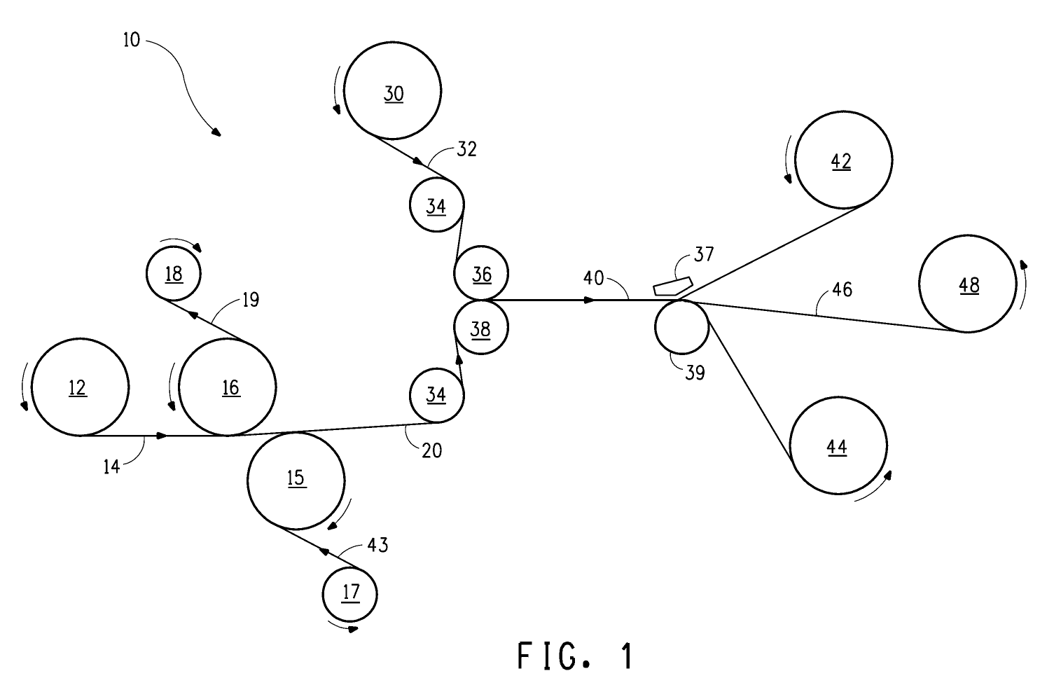

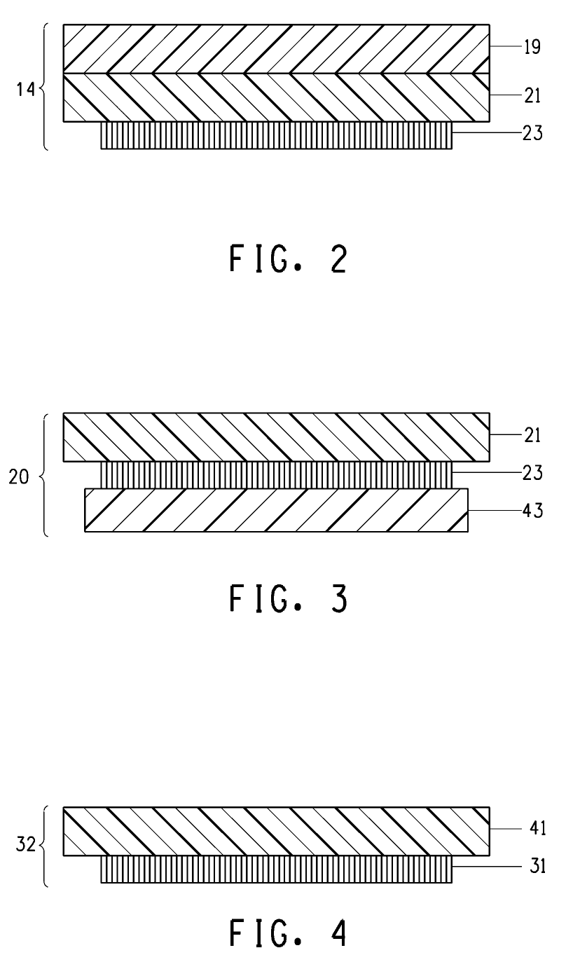

Embodiments of the disclosed process for manufacturing a CCM are now described with reference to the drawings. As shown in FIG. 1, a fluorinated polymer membrane is unrolled from a roll 12. At the point indicated by the reference character 14 in FIG. 1, and as shown in the cross sectional view in FIG. 2, a layered structure 14 is provided from the roll 12. Structure 14 includes a dimensionally stable substrate 19 as described above. A fluorinated membrane 21, as described above is releasably adhered to the substrate 19. An electrode 23, formed from an electrocatalyst coating composition as described above, is formed on the side of the membrane 21 opposite the support substrate 19. In the process shown in FIG. 1, the support substrate 19 is removed from the membrane 21 at the roller 16 and collected on a take-up roll 18. A release layer 43 provided from a supply roll 17 is applied onto the surface of the electrode 23 at the roller 15. After removal of the support substrate 19 and application of the release layer 43, a layered structure 20 remains at the point indicated by the reference character 20 in FIG. 1, and as shown in the cross sectional view of FIG. 3. The structure 20 includes the membrane 21 with an electrode 23 adhered to one side of the membrane and a release layer 43 covering the electrode 23. Release layer 43 is provided for process safety reasons and to improve the quality of the CCM made by the disclosed process.

In process shown in FIG. 1, an electrode decal is provided from a roll 30. The electrode decal comprises a second electrode on a stable release substrate. The electrode decal is prepared by: (1) providing a second electrocatalyst coating composition as described above;

(2) providing a dimensionally stable release layer having a surface;
(3) applying the second electrocatalyst coating composition on at least a portion of the surface of the dimensionally stable release layer; and
(4) drying the second electrocatalyst coating composition on the release layer to form an electrode decal on the dimensionally stable release layer. At the point indicated by the reference character 32 in FIG. 1, and as shown in the cross sectional view of FIG. 4, the electrode decal 31 has a first surface releasably attached to the dimensionally stable release layer 41 and an opposite second surface.

In the process embodiment shown in FIG. 1, the membrane 21 with electrode 23, and the electrode decal 31, are guided by the rollers 34 to a roll laminator. The second surface of the electrode decal 31 is applied to the first surface of the fluorinated polymer membrane 21 so as to form a sandwich of the polymer membrane 21 between the first electrode 23 and the electrode decal 31. According to the disclosed process, the sandwich of the polymer membrane between the first electrode and the electrode decal is passed through a compression nip formed between a heated roller 36 and another roller 38 so as to adhere the electrode decal to the membrane.

In the process disclosed herein, the heated roller 36 and the other roller 38 forming the compression nip may be the rollers of a hot roll lamination machine. In one preferred embodiment of the described process, the other roller 38 also is heated. The temperature of the heated roller 36 may be in the range of 120° C. to 160° C. It is preferred that the pressure applied in the compression nip be in the range of 80 to 150 psi, and more preferably be in the range of 90 to 110 psi, and most preferably bin in the range of 90 to 100 psi, as measured using a disposable pressure sensing film (available from Fuji Film). In the embodiment disclosed in FIG. 1, the sandwich passes though the compression nip at a linear speed in the range of 0.1 to 1 m/minute, and more preferably at a linear speed of about 0.4 m/min. In one embodiment, the hot roll laminator consists of one or two electrically heated rollers of 2″ diameter where each roll has a 0.065″ thick rubber covering with Durometer hardness approximately 70 Shore A, and in which the force that generates the nip pressure is applied by air cylinders at the roller shaft ends.

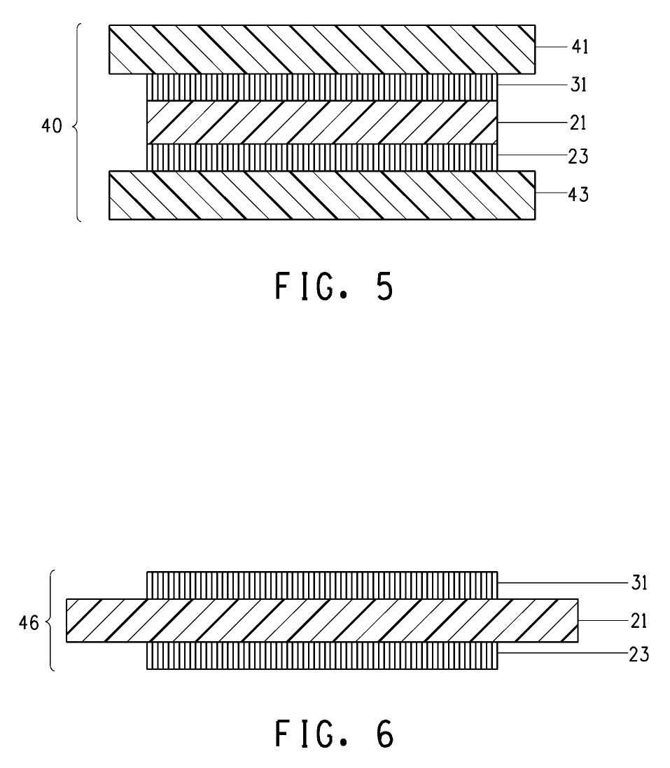

At the point indicated by the reference character 40 in FIG. 1, and as shown in the cross sectional view of FIG. 5, a CCM is produced in which electrodes 23 and 31 are adhered to opposite sides of the membrane 21. Electrode 23 is covered by the release layer 43 and the transferred electrode decal 31 is covered by the release layer 41. The CCM can be rolled up with one or both of the release layers 41 and 43 in place, or the release layer 41 may be removed by a peel bar 37, as shown in FIG. 1, or by a roller (not shown) and collected on the roll 42. Likewise, the release layer 43 may be removed from the electrode 23 by a roller 39 or by a peel bar (not shown) and collected on the take-up roll 44. Upon removal of the release layers 41 and 43, a CCM 46 remains at the point indicated by the reference character 46 in FIG. 1, and as shown in the cross sectional view of FIG. 6. The CCM 46 may be collected on the take-up roll 46, or it may alternatively be fed directly to a cutting device that cuts the CCM strip into individual CCM units for MEAs.

The exposed first surface of the transferred electrode decal 31 has a visual surface appearance that is different and more reflective than the visual surface appearance of the exposed second surface of the first electrode 23. The exposed first surface of the electrode decal has been found to have a gloss, measured according to a NovoGloss Glossmeter (at 85 degrees), that is at least 10 times greater than the gloss of the exposed second surface for the first electrode. Typically, the gloss of the exposed first surface of the electrode decal is in the range of 10 to 20 gloss units, and the gloss of the exposed second surface of the first electrode is in the range of 0 to 2 gloss units. The exposed first surface of the electrode decal mirrors the smooth surface of the stable release layer on which the electrode decal was coated and from which the electrode decal was transferred. This gives the exposed surface of the decal electrode a much higher reflectance then the exposed surface of the first electrode, which was exposed at the time the first electrode was coated onto the membrane and formed.

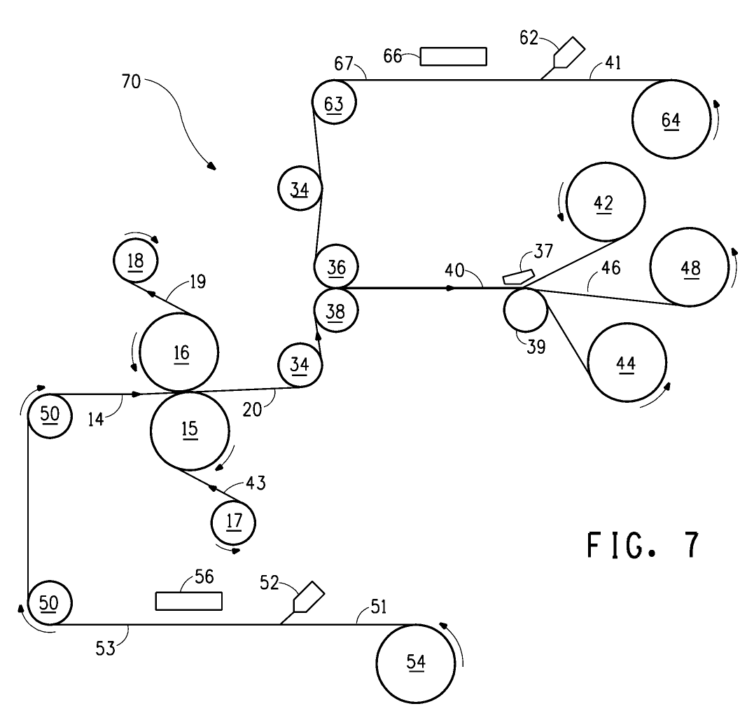

Another embodiment of the process described herein is shown in FIG. 7. In the process shown in FIG. 7, the electrodes are applied to the proton exchange membrane as part of a continuous process for making a CCM. As shown in FIG. 7, a fluorinated polymer membrane is unrolled from a roll 54. At the point indicated by the reference character 51 in FIG. 7, and as shown in the cross sectional view in FIG. 10, a layered structure 51 is provided from the roll 54. Structure 51 includes a dimensionally stable substrate 19 as described above. A fluorinated membrane 21, as described above is releasably adhered to the substrate 19.

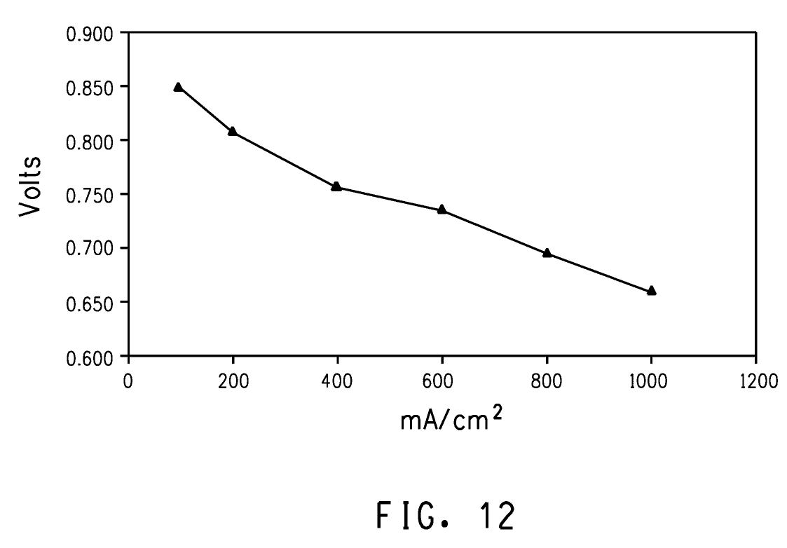

An electrocatalyst coating composition as described above is provided from a slot die coater 52 onto the exposed surface of the membrane 21 that is opposite from the support substrate 19. The electrocatalyst coating composition is dried by the dryer 56 so as to form an electrode 23 on the membrane 21. At the point indicated by the reference character 53 in FIG. 7, and as shown in the cross sectional view in FIG. 11, a layered structure 53 results that comprises the support substrate 19, the membrane 21 and the electrode 23.

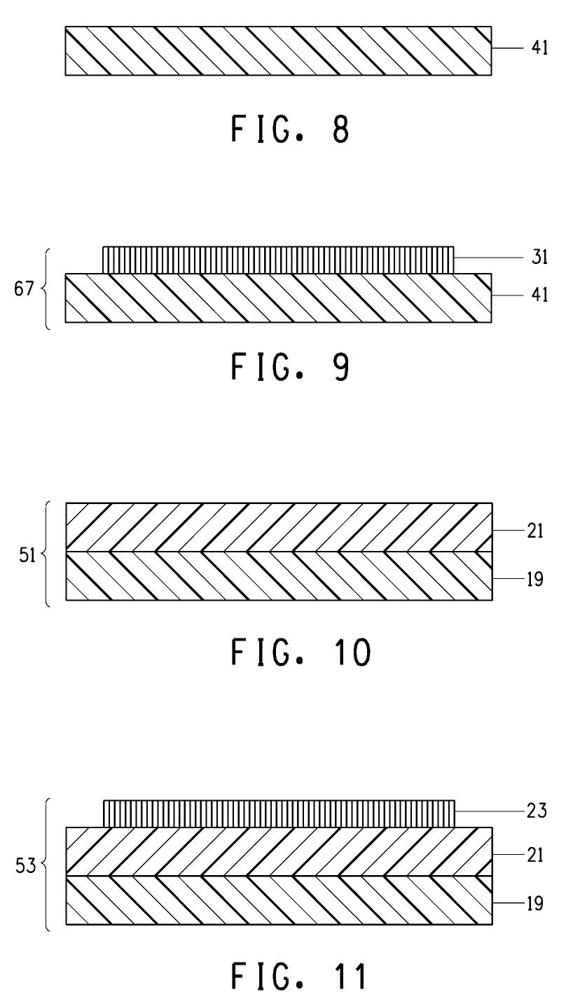

In the process shown in FIG. 7, a dimensionally stable release substrate 41 is provided from the roll 64. At the point indicated by the reference character 41 in FIG. 7, and as shown in the cross sectional view in FIG. 8, the release substrate 41 has no additional layers. An electrocatalyst coating composition, as described above, is provided from a slot die coater 62 onto the exposed surface of the release substrate 41. The electrocatalyst coating composition is dried by the dryer 66 so as to form an electrode decal 31 on the release substrate 41. At the point indicated by the reference character 67 in FIG. 7, and as shown in the cross sectional view in FIG. 9, a layered decal structure 67 results that comprises the release substrate 41 and the electrode decal 31. The dryers 56 and 66 are typically hot air dryers that blow air at a temperature in the range of 80 to 160° F., but may alternatively be other dryers know in the art such as UV radiation dryers.

In the process shown in FIG. 7, the layered structure 53 is passed by rollers 50 to a point where the support substrate 19 is removed from the membrane 21 at the roller 16 and collected on a take-up roll 18. A release layer 43 provided from a supply roll 17 is applied onto the surface of the electrode 23 at the roller 15. As shown in FIG. 7, the release layer 43 may be applied over the electrode at the same point that the support substrate is removed from the membrane 21. Alternatively, these operations can be performed sequentially as shown in FIG. 1. After removal of the support substrate 19 and application of the release layer 43, a layered structure 20 remains at the point indicated by the reference character 20 in FIG. 7, and as shown in the cross sectional view of FIG. 3. The structure 20 includes the membrane 21 with an electrode 23 adhered to one side of the membrane and a release layer 43 covering the electrode 23. Release layer 43 is provided for process safety reasons and to improve the quality of the CCM made by the disclosed process.

In the process embodiment shown in FIG. 7, rollers 63 and 34 bring the electrode decal 31 and the membrane 21 into the vicinity of each other. The second surface of the electrode decal 31 is applied to the first surface of the fluorinated polymer membrane 21 so as to form a sandwich of the polymer membrane 21 between the first electrode 23 and the electrode decal 31. According to the disclosed process, the sandwich of the polymer membrane between the first electrode and the electrode decal is passed through a compression nip formed between a heated roller 36 and another roller 38 so as to adhere the electrode decal to the membrane.

In the process shown in FIG. 7, the heated roller 36 and the other roller 38 forming the compression nip may be the rollers of a hot roll lamination machine as described and discussed above in relation to the process shown in FIG. 1. As discussed above, the other roller 38 may also be heated. The temperature of the heated roller 36 is typically in the range of 120° C. to 160° C. and the pressure applied in the compression nip is typically in the range of 80 to 150 psi, and more preferably be in the range of 90 to 110 psi, when measured using a disposable pressure sensing film. As previously discussed with regard to the process shown in FIG. 1, in the process shown in FIG. 7, the laminate also passes though the compression nip at a linear speed in the range of 0.1 to 1 m/minute, and more preferably at a linear speed of about 0.4 m/min.

At the point indicated by the reference character 40 in FIG. 7, and as shown in the cross sectional view of FIG. 5, a CCM is produced in which electrodes 23 and 31 are adhered to opposite sides of the membrane 21. Electrode 23 is covered by the release substrate 43 and the transferred electrode decal 31 is covered by the release substrate 41. The CCM can be rolled up with one or both of the release substrates 41 and 43 in place, or the release substrate 41 may be removed by a peel bar 37, and shown in FIG. 7, or by a roller (not shown) and collected on the roll 42. Likewise, the release substrate 43 may be removed from the electrode 23 by a roller 39 or by a peel bar (not shown) and collected on the take-up roll 44. Upon removal of the release substrates 41 and 43, a CCM 46 remains at the point indicated by the reference character 46 in FIG. 7, and as shown in the cross sectional view of FIG. 6. The CCM 46 may be collected on the take-up roll 46, or it may alternatively be fed directly to a cutting device that cuts the CCM strip into individual CCM units for MEAs.

As in the process described with regard to FIG. 1, the CCM manufacturing process shown in FIG. 7 produces a CCM in which the exposed first surface of the electrode decal has been found to have a gloss, measured according to a NovoGloss Glossmeter (at 85 degrees), that is at least 10 times greater than the gloss of the exposed second surface for the first electrode. Typically, the gloss of the exposed first surface of the electrode decal is in the range of 10 to 20 gloss units, and the gloss of the exposed second surface of the first electrode is in the range of 0 to 2 gloss units.

### EXAMPLES

The following specific example is intended to illustrate the practice of the invention and should not be considered to be limiting in any way.

### Catalyst Coating Composition

117 grams of Nafion® 920 EW dispersion in proton form (DuPont DE2020, 21.3% solids), and 223 grams of n-propyl alcohol (“NPA”), and 274 grams of iso-propyl alcohol (“IPA”) were added to a 0.5 gallon poly jar which was then immersed in an ice bath. The poly jar was in a nitrogen purged box in a hood. The container was cooled in the ice bath to bring down the solution temperature to ˜2° C. while stirring the solution at 600 rpm using a high speed mixer (BDC 2002 mixer made by Caframo) in a nitrogen atmosphere. 87 grams of carbon supported Pt catalyst (67 wt % Pt, 33 wt % particulate carbon) with a BET surface area of 215 m²/g (TEC10E70TPM catalyst obtained from Tanaka Kikinzoku Kogyo KK, Kanagawa, Japan) was added slowly to the Nafion® solution over a period of about 15 minutes while mixing continued. Stirring was continued for 10 minutes after the addition of all of the carbon supported Pt. This slurry was then recirculated in a small media mill (model MK11 M100 by Eiger Machinery) for 5 minutes at 4000 rpm. The mill was 75% loaded with ZirPro ER120 ceramic beads. After milling, dipropylene-glycol monomethyl ether (Dowanol DPM from Dow Chemical) was added at a level so as to comprise 10 wt % of the solvents. The ink was then diluted to 12% solids prior to slot die coating using a blend of 43 wt % NPA, 42 wt % IPA, 10 wt % DPM and 6 wt % deionized water. The viscosity of the catalyst ink was 300 centipoise at 20 s−1 shear rate.

### Electrode Decal

Cathode electrode decal was prepared by slot die coating the catalyst ink described above onto a 20 cm wide×20 meter long strip of a 2 mil thick perfluoroalkoxy film (DuPont Teflon® PFA type 200LP) release layer at room temperature. The smooth surface of the PFA leads to the high gloss of the transferred decal. The slot die opening was 0.007 inch thick and 6.75 inches wide. Air heated to 120° F. was blown onto the catalyst ink for 4 minutes to dry the catalyst ink. The platinum loading was measured by X-ray fluorescence to be 0.5 mg Pt/cm². The dry coating thickness was about 0.3 mil (7.6 microns). The catalyst loading was measured using an XRF instrument.

### Catalyst Coated Membrane

A 20 cm wide and 15 m long sheet of Nafion® NRE-211 perfluorosulfonic acid 1 mil cast membrane adhered to a dimensionally stable 2 mil thick polyester film was provided. An 6.75 inch wide anode electrode was prepared by slot die coating the catalyst ink described above onto the Nafion® NRE-211 membrane at room temperature. The slot die opening was 0.007 inch thick and 6.75 inches wide. Air heated to 140° F. was blown onto the catalyst ink for 2 minutes to dry the catalyst ink. The platinum loading was measured by X-ray fluorescence to be 0.1 mg Pt/cm². The dry coating thickness was about 0.1 mil (2.5 microns). The catalyst loading was measured using an XRF instrument.

The cathode electrode decal described above was transferred from Teflon® PFA by hot lamination to the uncoated side of the Nafion® NRE-211 membrane. This was accomplished by laying the cathode electrode decal on the uncoated side of the coated membrane and passing the coated membrane and decal through the heated nip of a Riston HRL-24 hot roll laminator. The cathode decal was unwound from the hot roll laminator top position, so that the electrode side of the decal faced down as it entered the nip rollers. The coated Nafion® NRE-211 membrane was unwound from the lower position of the hot roll laminator with its coated side down. The edges of the electrode decal were carefully registered with the edges of the coated electrode on the opposite side of the membrane. An additional carrier film of Teflon® PFA 200LP was inserted between the anode and the hot nip roller surface for safety reasons. The two rollers forming the nip each had a 2 inch diameter and was 24 inches wide. Each roller had a 0.065″ rubber covering. The nip rolls are wrapped 90 degrees with the films. The coated membrane and electrode decal passed though the nip of the laminator at a linear speed of 0.4 m/min and the surface of the two laminator nip rollers were maintained at a temperature of 140° C. The nip pressure was 90-100 psi. The PFA decal release layer was subsequently removed and the remaining catalyst coated membrane (“CCM”) was wound up onto a take-up roll. The carrier film of Teflon® PFA 200LP was also collected on a take up roll. The CCM was subsequently unwound from the roll and manually cut into squares for testing. Each CCM square was approximately 6.5″×6.5″.

### Testing

The surface gloss of the CCM surfaces were measured using a Novo-Gloss Glossmeter, at 85 degree angle

Cathode surface, average of 5 readings=15.4

Anode surface, average of 5 readings=1.3

The performance of the CCM was measured employing a single cell test assembly obtained from Fuel Cell Technologies Inc, New Mexico. Membrane electrode assemblies were made that comprised one of the above CCMs sandwiched between two sheets of the gas diffusion backing (taking care to ensure that the GDB covered the electrode areas on the CCM). The edges of the CCMs were sealed with Teflon® FEP gaskets so there was no exposed membrane at the edges. The anode and cathode gas diffusion backings were comprised of a 12 mil thick nonwoven carbon fabric (31DC GDL, from SGL Carbon Group of Germany). Two 9 mil thick FEP gaskets each along with a 1 mil thick FEP polymer spacer were cut to shape and positioned so as to surround the electrodes and GDBs on the opposite sides of the membrane Care was taken to avoid overlapping of the GDB and the gasket material. The entire sandwich assembly was assembled between the anode and cathode flow field graphite plates of a 25 cm² standard single cell assembly (obtained from Fuel Cell Technologies Inc., Los Alamos, N. Mex.). The test assembly was also equipped with anode inlet, anode outlet, cathode gas inlet, cathode gas outlet, aluminum end blocks, tied together with tie rods, electrically insulating layer and the gold plated current collectors. The bolts on the outer plates of the single cell assembly were tightened with a torque wrench to a force of 3 ft. lbs.

The single cell assembly was then connected to the fuel cell test station. The components in a test station include a supply of air for use as cathode gas; a load box to regulate the power output from the fuel cell; a supply of hydrogen for use as the anode gas. With the cell at room temperature, hydrogen and air were introduced into the anode and cathode compartments through inlets of the cell at flow rates of 693 cc/min and 1650 cc/min, respectively. The temperature of the single cell was slowly raised until it reached 70° C. The theoretical value for both air and H2 stoich is 1. This corresponds to 100% utilization of air and hydrogen. The relationship between stoich and utilization is: % utilization=1/stoich×100. Thus, in the high pressure test and low pressure test protocols, which run at 2 stoich, the air and hydrogen % utilization is 50%. The cell back pressure is controlled by restricting the exit flow in the cell, which increases the overall system pressure. It is called back pressure because it is controlled at the cell outlet. The hydrogen and air feed rates were maintained proportional to the current while the resistance in the circuit was varied in steps so as to increase current. The cell voltage at a current density of 1 amps/cm² was measured and recorded below.

The fuel cell performance was measured for the sample, at 100% RH and 65° C. At a current density of 1 A/cm², the voltage of the cell was 667 mV, which compares favorably to a commercial standard of 635 mV. A voltage vs. current density plot for the sample of the Examples is attached as FIG. 12.

What is claimed is:

1. A process for manufacturing a catalyst coated membrane comprising:
(a) providing a fluorinated polymer membrane having a first surface adhered to a dimensionally stable substrate and an opposite second surface;
(b) providing a first electrocatalyst coating composition comprised of a fluorinated polymer, a catalyst and a liquid medium, said liquid medium being comprised of greater than 70 wt % of a liquid having a boiling point less than 120° C.;
(c) applying said first electrocatalyst coating composition on at least a portion of the second surface of the membrane;
(d) drying the electrocatalyst coating composition on the second surface of the membrane to form a first electrode on the membrane, said first electrode having a first surface adjacent to the second surface of the membrane and an opposite exposed second surface;
(e) providing an electrode decal on a dimensionally stable release substrate, said electrode decal prepared by the following steps:
(1) providing a second electrocatalyst coating composition comprised of a fluorinated polymer, a catalyst and a liquid medium, said liquid medium comprised of greater than 70 wt % of a liquid having a boiling point less than 120° C.;
(2) providing a dimensionally stable release substrate having a surface;
(3) applying said second electrocatalyst coating composition on at least a portion of the surface of the dimensionally stable release substrate;
(4) drying the second electrocatalyst coating composition on the release substrate to form an electrode decal on the dimensionally stable release substrate, said electrode decal having a first surface adjacent to the dimensionally stable release substrate and an opposite second surface;
(f) removing the first dimensionally stable substrate from the first surface of the polymer membrane;
(g) applying the second surface of the electrode decal to the first surface of the polymer membrane so as to form a sandwich of the polymer membrane between the first electrode and the electrode decal;
(h) passing said sandwich through a compression nip formed between a heated roller and another roller to adhere the electrode decal to the membrane;
(i) removing the dimensionally stable release substrate from the first surface of the electrode decal to expose the first surface of the electrode decal, the exposed first surface of the electrode decal having a visual surface appearance that is different and more reflective than the visual surface appearance of the exposed second surface of the first electrode.

2. The process of claim 1 wherein the heated roller and the other roller forming the compression nip of step (h) are rollers of a hot roll lamination machine.

3. The process of claim 2 wherein the other roller is heated.

4. The process of claim 1 wherein a cover sheet is applied over exposed second surface of the first electrode prior to step (h) and the cover sheet is removed from the second surface of the first electrode after step (h).

5. The process of claim 1 wherein the liquid medium of step (e) (1) is an organic solvent comprised of at least 70 wt % of alcohol having a boiling point of less than 100° C.

6. The process of claim 5 wherein the alcohol is propanol.

7. The process of claim 1 wherein in step (i), the exposed first surface of the electrode decal has a gloss that is at least 10 times greater than the gloss of the exposed second surface for the first electrode, where gloss is measured using a NovoGloss Glossmeter (at 85 degrees).

8. The process of claim 7 wherein the gloss of the exposed first surface of the electrode decal is in the range of 10 to 20 gloss units, and the gloss of the exposed second surface of the first electrode is in the range of 0 to 2 gloss units.

9. The process of claim 1 wherein in step (c), the electrocatalyst coating composition is applied to the second surface of the membrane by printing or coating.

10. The process of claim 9 wherein the electrocatalyst coating composition is applied to the second surface of the membrane by die coating.

11. The process of claim 1 wherein the fluorinated polymer of the membrane of step (a), the fluorinated polymer of the first electrocatalyst coating composition of step (b), and the fluorinated polymer of the electrocatalyst coating composition of step (e)(1) are the same highly fluorinated polymer.

12. A continuous process for manufacturing a catalyst coated membrane comprising:
(a) providing a continuous strip of a fluorinated polymer membrane having a first surface adhered to a dimensionally stable substrate and an opposite second surface;
(b) providing to an applicator a first electrocatalyst coating composition comprised of a fluorinated polymer, a catalyst and a liquid medium, said liquid medium being comprised of greater than 70 wt % of a liquid having a boiling point less than 120° C.;
(c) continuously passing the strip of fluorinated polymer membrane on the dimensionally stable substrate past the applicator and applying said first electrocatalyst coating composition from the applicator on at least a portion of the second surface of the membrane passing the applicator;
(d) continuously passing the strip of fluorinated polymer membrane, dimensionally stable substrate and first electrocatalyst coating composition through a dryer to dry the first electrocatalyst coating composition on the second surface of the membrane so as to form a first electrode on the membrane strip, said first electrode having a first surface adjacent to the second surface of the membrane and an opposite exposed second surface;
(e) providing a continuous strip of an electrode decal comprising a strip of electrode decal on a dimensionally stable release substrate, said strip of electrode decal being prepared by
(1) providing a second electrocatalyst coating composition comprised of a fluorinated polymer, a catalyst and a liquid medium, said liquid medium comprised of greater than 70 wt % of a liquid having a boiling point less than 120° C.;
(2) providing a strip of a dimensionally stable release substrate having a surface;
(3) applying said second electrocatalyst coating composition on the surface of the strip of the dimensionally stable release substrate;
(4) drying the second electrocatalyst coating composition on the strip of the release substrate to form an electrode decal strip on the dimensionally stable release substrate strip, said electrode decal strip having a first surface adjacent to the dimensionally stable release substrate and an opposite second surface;
(f) continuously removing the first dimensionally stable substrate from the first surface of the strip of the fluorinated polymer membrane;
(g) continuously applying the second surface of the electrode decal strip to the first surface of the polymer membrane strip so as to form a sandwich of the polymer membrane between the first electrode and the electrode decal;
(h) continuously passing said sandwich through a compression nip formed between a heated roller and another roller to adhere the electrode decal strip to the membrane strip;
(i) continuously removing the dimensionally stable release substrate from the first surface of the electrode decal strip to expose the first surface of the electrode decal, the exposed first surface of the electrode decal having a visual surface appearance that is different and more reflective than the visual surface appearance of the exposed second surface of the first electrode.

13. The process of claim 12 wherein the heated roller and the other roller forming the compression nip of step (h) are rollers of a hot roll lamination machine.

14. The process of claim 13 wherein the other roller is a heated roller.

15. The process of claim 12 wherein a cover sheet is continuously applied over the exposed second surface of the first electrode prior to step (h) and the cover sheet is continuously removed from the second surface of the first electrode after step (h).

16. A catalyst coated membrane comprising:
(a) a membrane comprised of a fluorinated polymer having a first surface and a second surface;
(b) a first electrode comprised of a fluorinated polymer and a catalyst, said first electrode having a first surface adhered to the second surface of the membrane and an opposite exposed second surface; and
(c) a second electrode comprised of a fluorinated polymer and a catalyst, said second electrode having a second surface adhered to the first surface of the membrane and an opposite exposed first surface, wherein the exposed first surface of the second electrode has a surface appearance that is different and more reflective than the visual appearance of the exposed second surface of the first electrode.

17. The catalyst coated membrane of claim 16 wherein the exposed first surface of the second electrode has a gloss that is at least 10 times greater than the gloss of the exposed second surface for the first electrode, where gloss is measured using a NovoGloss Glossmeter (at 85 degrees).

18. The catalyst coated membrane of claim 17 wherein the gloss of the exposed first surface of the second electrode is in the range of 10 to 20 gloss units, and the gloss of the exposed second surface of the first electrode is in the range of 0 to 2 gloss units, where gloss is measured using a NovoGloss Glossmeter (at 85 degrees).

19. The catalyst coated membrane of claim 16 wherein said membrane further comprises a porous reinforcement material incorporated into the membrane.

20. A membrane electrode assembly comprising the catalyst coated membrane of claim 16.
